(19) United States
(12) Patent Application Publication
(10) Pub. No.: US 2022/0022502 A1
(43) Pub. Date: Jan. 27, 2022

(54) Method of manufacturing vegan kimchi and vegan kimchi prepared using the same

(71) Applicants: Yunjung Jang, Yongin-si (KR); GHIRUM CO., Ltd., Hongcheon-gun (KR)

(72) Inventors: Young Soon SHIM, Seoul (KR); Yunjung Jang, Yongin-si (KR); JU Yeen Lee, Seoul (KR); Jin Young Kim, Bucheon-si (KR)

(21) Appl. No.: 17/479,422

(22) Filed: Sep. 20, 2021

(30) Foreign Application Priority Data
Jul. 22, 2020 (KR) 10-2020-0090672

(51) Int. Cl. A23L 19/20; A23L 27/12; A23L 27/14; A23B 7/10

(52) U.S. Cl. CPC A23L 19/20; A23B 7/105; A23L 27/14; A23L 27/12

(57) ABSTRACT

The present invention relates to a method of preparing vegan kimchi, which includes a first salting step of first salting napa cabbage using salting water; a second salting step of second salting the first salted napa cabbage using a second salting mixture; and a condiment mixing step of mixing the second salted napa cabbage with vegan kimchi condiment. The prepared vegan kimchi retains the characteristics and taste of general kimchi, has crunchy characteristics since the vegan kimchi is salted two times using salty and sweet ingredients during the salting process, has excellent preservability since the vegan kimchi has a slightly slower growth rate of lactobacillus than general kimchi containing animal ingredients, and thus has an effect of being easily commercialized and sold.

### BACKGROUND OF THE INVENTION

### Field of the Invention

The present invention relates to a method of preparing vegan kimchi and vegan kimchi prepared by the same, more specifically to a method of preparing vegan kimchi that does not contain animal ingredients and can be thus consumed by vegans, and vegan kimchi prepared by the same.

### Description of the Related Art

Background to the present disclosure is provided herein, which does not necessarily imply known art.

Kimchi is a product that is prepared by salting white radish, napa cabbage, cucumber and the like, marinating the salted vegetables with condiment composed of Korean red chili, garlic, green onion, ginger, salted fish and the like, and then ripening and fermenting the salted and marinated vegetables at low temperatures by lactic acid production. Kimchi is an essential side dish served at the Korean meals. Lactobacillus and organic acids, which increase as kimchi ripens, and dietary fibers play an important role in prevention of colorectal cancer by cleaning the intestines for intestinal regulation and diminishing the activity of carcinogens in the intestine and the pH of the colon, and prevent arteriosclerosis by diminishing the amount of bad serum cholesterol in the body and promoting the degradation of fibrin that forms blood clot. Kimchi is rich in antioxidants such as vitamin C, beta-carotene, phenolic compounds, and chlorophyll, which inhibit aging. In particular, since ingredients such as green onion, garlic, Korean red chili, and ginger, which are minor ingredients, also exhibit high antioxidant properties, so kimchi has an effect of forming new collagen, maintaining a thick skin tissue, and softening the stratum corneum.

Due to the efficacy of kimchi, the demand for kimchi is increasing not only domestically but also internationally, and research and development are actively underway to prepare kimchi that is nutritionally excellent as well as is delicious and fragrant.

Meanwhile, vegetarians may be classified into pesco-vegetarian, lacto-ovo-vegetarian, ovo-vegetarian, lacto-vegetarian, and vegan depending on the extent. Vegans are those who consume only vegetables but do not consume meat, seafood, eggs, or dairy products, and do not consume cabbage kimchi prepared using general salted fish, seasonings, and broth obtained from animal ingredients (anchovy, large-eyed herring and the like).

However, it is greatly difficult to control the fermentation of kimchi without adding animal ingredients such as salted fish and seafood. Hence, except for pesco-vegetarians who consume fish but do not consume only poultry, including red meat, and birds, vegetarians who do not consume fish or seafood cannot consume kimchi.

### CITATION LIST

### Patent Literature

Patent Literature 1: Korea Patent No. 10-2031081 (2019.10.04)

Patent Literature 2: Korean Patent No. 10-1517923 (2015.04.29)

### SUMMARY OF THE INVENTION

The present invention is to provide a method of preparing vegan kimchi that can be consumed even by vegans who do not consume any animal ingredients, provides a taste equal to or greater than that of general kimchi, and has excellent preservability, and vegan kimchi prepared by the same.

However, the objects of the present invention are not limited to the above-mentioned objects, and other objects not mentioned will be clearly understood by those skilled in the art from the following description.

The present invention provides a method of preparing vegan kimchi, which includes a first salting step of first salting napa cabbage using salting water containing refined salt and purified water; a second salting step of second salting the first salted napa cabbage using a salty and sweet second salting mixture; and a condiment mixing step of mixing the second salted napa cabbage with vegan kimchi condiment, and in which the condiment mixing step is a step of mixing the second salted napa cabbage with vegan kimchi condiment prepared by soaking Korean red chili flakes in ingredients, which are not salty, and then mixing the soaked red chili flake mixture with salty ingredients.

The first salting step is a step of dissolving refined salt in purified water to prepare salting water having a concentration of 10% to 15%, salting trimmed napa cabbage using the salting water, washing the salted napa cabbage, and draining the washed napa cabbage to obtain first salted napa cabbage, and the first salting time is 16 to 20 hours, the draining time is 19 to 23 hours.

The second salting step is a step of salting the first salted napa cabbage using a second salting mixture containing grated white radish, grated onion, roasted salt, and sugar and draining the salted napa cabbage to obtain second salted napa cabbage, and the second salting time is 50 to 70 minutes, and the draining time is 20 to 40 minutes.

The condiment mixing step is a step mixing the second salted napa cabbage with vegan kimchi condiment containing Korean red chili flakes, grated white radish, grated onion, grated apple, vegetable broth, glutinous rice paste, grated garlic, grated ginger, soy sauce, refined salt, sugar, and sliced green onion, and the vegan kimchi condiment is prepared by soaking Korean red chili flakes in grated white radish, grated onion, grated apple, vegetable broth, and glutinous rice paste for 100 to 150 minutes to obtain a soaked red chili flake mixture and then mixing the soaked red chili flake mixture with soy sauce, sugar, grated garlic, grated ginger, sliced green onion, and refined salt.

The vegetable broth is obtained by adding at least three or more ingredients selected from the group consisting of cabbage, potato, white radish, onion, kelp, green onion, Cheongyang chili pepper, dried shiitake mushroom, and dried chili seed to purified water, boiling the mixture for 15 to 25 minutes, cooling the boiled mixture, and straining the boiled mixture through a strainer.

The present invention also provides vegan kimchi condiment containing Korean red chili flakes at 10 to 13 wt %, grated white radish at 5 to 7 wt %, grated onion at 22 to 25 wt %, grated apple at 0.1 to 0.8 wt %, vegetable broth at 15 to 22 wt %, glutinous rice paste at 5 to 7 wt %, grated garlic at 10 to 15 wt %, grated ginger at 1 to 4 wt %, soy sauce at 2 to 5 wt %, refined salt at 0.5 to 2.5 wt %, sugar at 4 to 8 wt %, and sliced green onion at 5 to 10 wt %.

The vegetable broth contains components extracted from at least three or more ingredients selected from the group consisting of cabbage, potato, white radish, onion, kelp, green onion, Cheongyang chili pepper, dried shiitake mushroom, and dried chili seed.

The present invention provides vegan kimchi that is kimchi containing napa cabbage and vegan kimchi condiment, and in which the salted napa cabbage is napa cabbage which is first salted using salting water containing refined salt and purified water and then second salted using a salty and sweet second salting mixture.

### BRIEF DESCRIPTION OF THE DRAWINGS

FIG. 1 illustrates a graph for comparing the fermentation rate of lactobacillus in vegan kimchi according to an embodiment of the present invention to that in general kimchi;

FIG. 2 illustrates a graph for comparing the pH of vegan kimchi according to an embodiment of the present invention to that of general kimchi;

FIG. 3 illustrates a graph for comparing the sugar content in vegan kimchi according to an embodiment of the present invention to that in general kimchi; and

FIG. 4 illustrates a graph for comparing the salinity of vegan kimchi according to an embodiment of the present invention to that of general kimchi.

### DETAILED DESCRIPTION OF THE PREFERRED EMBODIMENTS

All technical and scientific terms used herein have the same meanings as meanings commonly understood by those skilled in the art, unless otherwise stated. Also throughout this specification and claims, unless otherwise stated, the terms “comprise, comprises, comprising” are meant to include the recited object, step or group of objects, and steps, and is not used to exclude any other object, step or group of objects or group of steps.

Prior to describing the present invention in detail below, it is to be understood that the terminology used herein is for the purpose of describing specific embodiments only and is not intended to limit the scope of the present invention, which is limited only by the appended claims.

Meanwhile, various embodiments of the present invention may be combined with any other embodiments unless clearly indicated to the contrary. Any feature indicated as particularly preferred or advantageous may be combined with any other feature and features indicated as preferred or advantageous. Hereinafter, embodiments of the present invention and effects thereof will be described with reference to the accompanying drawings.

The method of preparing vegan kimchi according to an embodiment of the present invention includes a first salting step of first salting napa cabbage using salting water; a second salting step of second salting the first salted napa cabbage using a second salting mixture; and a condiment mixing step of mixing the second salted napa cabbage with vegan kimchi condiment.

Various microorganisms and enzymes are working in the ripening of kimchi, the most important action is lactic acid fermentation by lactobacillus, and this fermentation not only gives the taste of kimchi but also improves the preservability of kimchi. Lactic acid produced by lactic acid fermentation suppresses the activity of putrefactive bacteria together with other organic acids as well as harmonizes with vegetable ingredients and creates a unique taste of kimchi. In general, kimchi is delicious and the content of vitamin C is the highest at a pH of 4.2 to 4.0 and an acidity of about 0.3 to 0.7.

The vegan kimchi prepared according to the present invention retains the characteristics and taste of general kimchi, provides crunchy physical characteristics since the vegan kimchi is salted two times using spice juice during the salting process. The vegan kimchi also provides an effect of having excellent preservability since the vegan kimchi has a slightly slower growth rate of lactobacillus than general kimchi.

Hereinafter, a specific method of preparing vegan kimchi according to an embodiment of the present invention will be described.

The first salting step is a step of first salting napa cabbage using salting water, and is a step of first dissolving refined salt in purified water to prepare salting water having a concentration of 10% to 15% and salting trimmed napa cabbage using the salting water.

More specifically, salting water having a concentration of 10% to 12% is used in the summer season, and salting water having a concentration of 12% to 15% is used in the winter season. Since the external temperature is low in the winter season, the salted degree in the winter season is lower than that in the summer season, and thus salting water having a concentration higher than that in the summer season by 2% to 3% is used in the winter season.

The temperature of the room where the first salting step is performed is maintained at 14° C. to 18° C. The temperature is more preferably maintained at 15° C. to 17° C.

In the first salting step, napa cabbage is immersed in salting water and then salted for 16 to 20 hours, then washed one or two times with purified water, and then drained for 19 to 23 hours to obtain the first salted napa cabbage. Preferably, napa cabbage is immersed in salting water and then salted for 17 to 19 hours, then washed two times with purified water, and then drained for 20 to 22 hours to obtain the first salted napa cabbage.

The salinity of the first salted napa cabbage obtained according to the present invention is maintained at 1.4% to 1.85%. The concentration of the salting water used in the first salting is 6% to 8%.

The second salting step is a step of second salting the first salted napa cabbage using a second salting mixture, and is a step of second salting the first salted napa cabbage using a second salting mixture containing grated white radish, grated onion, roasted salt, and sugar.

The second salting mixture is used by 2.0 to 2.5 parts by weight based on 100 parts by weight of the first salted napa cabbage. The second salting mixture is prepared by mixing grated white radish at 45 to 50 wt %, grated onion at 45 to 50 wt %, roasted salt at 1 to 5 wt %, and sugar at 1 to 5 wt %. The second salting mixture is more preferably prepared by mixing grated white radish at 45 to 48 wt %, grated onion at 45 to 48 wt %, roasted salt at 2 to 4 wt %, and sugar at 2 to 4 wt %.

The prepared second salting mixture is sprayed toward the root part (white part) of the first salted napa cabbage, and then the first salted napa cabbage is salted for 50 to 70 minutes and drained for 20 to 40 minutes to obtain the second salted napa cabbage.

An effect of supplementing the lost taste of napa cabbage is obtained by the second salting, and an effect of releasing the fresh water, which has been impregnated into the napa cabbage during the first salting, from the first salted napa cabbage by osmosis is obtained by salting the first salted napa cabbage one more time in the salty and sweet second salting mixture. The second salted napa cabbage having a weight decreased by about 2% to 3% than that of the first salted napa cabbage is thus obtained.

The condiment mixing step is a step of mixing the second salted napa cabbage with vegan kimchi condiment, and is a step of mixing the second salted napa cabbage with vegan kimchi condiment containing Korean red chili flakes, grated white radish, grated onion, grated apple, vegetable broth, glutinous rice paste, grated garlic, grated ginger, soy sauce, refined salt, sugar, and sliced green onion.

More specifically, the vegan kimchi condiment is prepared by soaking Korean red chili flakes in grated white radish, grated onion, grated apple, vegetable broth, and glutinous rice paste for 100 to 150 minutes to obtain a soaked red chili flake mixture and then mixing the soaked red chili flake mixture with soy sauce, sugar, grated garlic, grated ginger, sliced green onion, and refined salt.

The vegan kimchi condiment is characterized by mixing Korean red chili flakes with watery ingredients and soaking for 2 or more hours before salty ingredients are added. In other words, the vegan kimchi condiment is characterized by thoroughly soaking Korean red chili flakes in ingredients (grated white radish, grated onion, grated apple, vegetable broth, and glutinous rice paste), which are not salty, then adding salty ingredients (soy sauce, salt, and the like) in order, and mixing all the ingredients together. The soaking of Korean red chili flakes is maximized and the color is vivid by soaking Korean red chili flakes in ingredients which are not salty, and an effect of the amount of Korean red chili flakes seeming to increase is obtained by mixing Korean red chili flakes with grated white radish and grated onion.

The vegan kimchi condiment contains Korean red chili flakes at 10 to 13 wt %, grated white radish at 5 to 7 wt %, grated onion at 22 to 25 wt %, grated apple at 0.1 to 0.8 wt %, vegetable broth at 15 to 22 wt %, glutinous rice paste at 5 to 7 wt %, grated garlic at 10 to 15 wt %, grated ginger at 1 to 4 wt %, soy sauce at 2 to 5 wt %, refined salt at 0.5 to 2.5 wt %, sugar at 4 to 8 wt %, and sliced green onion at 5 to 10 wt %.

The vegetable broth is added instead of the meat broth prepared using animal ingredients, and is obtained by adding at least three or more ingredients, preferably or more ingredients, more preferably 7 or more ingredients selected from the group consisting of cabbage, potato, white radish, onion, kelp, green onion, Cheongyang chili pepper, dried shiitake mushroom, and dried chili seed to purified water, boiling the mixture for 15 to 25 minutes, cooling the boiled mixture, and staining the boiled mixture through a strainer.

More specifically, with respect to 100 parts by weight of purified water, 3 to 7 parts by weight of cabbage is added in the case of adding the cabbage, 3 to parts by weight of potato is added in the case of adding the potato, 3 to 7 parts by weight of white radish is added in the case of adding the white radish, 1 to 3 parts by weight of onion is added in the case of adding the onion, 0.5 to 1.5 parts by weight of kelp is added in the case of adding the kelp, 0.5 to 1.5 parts by weight of green onion is added in the case of adding the green onion, 0.3 to 0.8 parts by weight of Cheongyang chili pepper is added in the case of adding the Cheongyang chili pepper, 0.1 to 0.3 parts by weight of dried shiitake mushroom is added in the case of adding the dried shiitake mushrooms, and 0.1 to 0.3 parts by weight of dried chili seed is added in the case of adding the dried chili seed.

The vegan kimchi condiment is mixed by 25 to 40 parts by weight, preferably 30 to 35 parts by weight with respect to 100 parts by weight of the first salted napa cabbage.

By mixing the second salted napa cabbage with the vegan kimchi condiment, vegan kimchi according to an embodiment of the present invention is obtained.

In another aspect, the vegan kimchi according to an embodiment of the present invention is kimchi in which vegan kimchi condiment is mixed with napa cabbage, which is first salted using salting water and then second salted using a second salting mixture, and there is provided vegan kimchi that does not contain animal ingredients.

The vegan kimchi contains salted napa cabbage and vegan kimchi condiment, and the vegan kimchi condiment contains Korean red chili flakes, grated white radish, grated onion, grated apple, vegetable broth, glutinous rice paste, grated garlic, grated ginger, soy sauce, refined salt, sugar, and sliced green onion.

The vegetable broth contains components extracted from at least three or more ingredients, preferably 5 or more ingredients, more preferably 7 or more ingredients selected from the group consisting of cabbage, potato, white radish, onion, kelp, green onion, Cheongyang chili pepper, dried shiitake mushroom, and dried chili seed.

The vegan kimchi according to the present invention has excellent preservability since the vegan kimchi has a slower growth rate of lactobacillus than general kimchi containing animal ingredients, and thus has an effect of being easily commercialized and sold.

### Examples

(1) First Salting Step

First, salting water (refined salt+purified water) was prepared to have a concentration of 10% to 12% (10% in the summer season, 12% in the winter season). The soil was removed from the root part of napa cabbage, the outermost leaves were removed from the napa cabbage, and the trimmed napa cabbage was washed one time with purified water and then cut. The cut napa cabbage was stacked one layer by one layer, and at this time, salt was sprinkled between the layers and the salting water was sprayed on the layers to briefly salt the napa cabbage. The layered napa cabbage was pressed with a pressing plate and a pressing container, then the salting water was added thereto, and salting was performed for 18 hours. At this time, the temperature of the salting room was adjusted to 16° C. The salted napa cabbage was washed two times with purified water and drained for 21 hours to obtain 100 kg of the first salted napa cabbage.

(2) Second Salting Step

The ingredients for second salting including 1 kg of grated white radish, 1 kg of grated onion, 0.08 kg of roasted salt, and 0.08 kg of sugar were mixed together, the mixture was sprinkled toward the root part of the cut side of the first salted napa cabbage, and salting was performed for about 1 hour. The napa cabbage was then turned over so that the cut side was facing down and drained for about 30 minutes to obtain 97.6 kg of second salted napa cabbage.

(3) Condiment Mixing Step

Mixed were 1.95 kg of grated white radish, 7.78 kg of grated onion, 0.13 kg of grated apples, 6.22 kg of vegetable broth, 1.95 kg of glutinous rice paste, and 3.86 kg of Korean red chili flakes to soak the Korean red chili flakes for 2 hours. Thereafter, the soaked Korean red chili flake mixture was mixed with 1.19 kg of Korean soy sauce, 1.86 kg of sugar, 3.88 kg of grated garlic, 0.77 kg of grated ginger, 2.32 kg of sliced green onion, and 0.52 g of refined salt to prepare kimchi condiment.

At this time, the vegetable broth was prepared by mixing the ingredients at the contents presented in the following Table 1 (based on 5 kg of purified water). The ingredients presented in the following Table 1 was put in purified water, boiled for 20 minutes after it started boiling, cooled as it is, and strained through a strainer.

The prepared kimchi condiment was applied to the second salted napa cabbage to obtain 127.71 kg of kimchi.

TABLE 1

| | | |
|---|---|---|
| Purified water | 5 | kg |
| Cabbage | 250 | g |
| Potato | 250 | g |
| White radish | 250 | g |
| Onion | 100 | g |
| Kelp | 50 | g |
| Green onion | 50 | g |
| Cheongyang chili pepper | 25 | g |
| Dried shiitake mushroom | 10 | g |
| Dried chili seed | 10 | g |

### Experimental Examples

(1) Measurement of Salinity Change According to First Salting Step

The salinity of the napa cabbage salted according to the first salting step of Example was measured and presented in the following Table 2. As presented in the following Table 2, three heads of napa cabbage were salted on the corresponding day, and the average salinity (%) thereof was measured, as a result, it can be seen that the average salinity is maintained at about 1.7%. The salting effect decreases in the winter season, that is, when the outside temperature is 5° C. or less, and it is thus recommended to adjust the temperature of the salting room to 16° C. on average and to increase the concentration of salting water by 2% to 3% from that in the summer season for salting.

TABLE 2

| | | | Average | Daily |
|---|---|---|---|---|
| | SA | Weight | salinity | average |
| Date | division | (g) | (%) | salinity (%) |
| February 19 | #1 | 940 | 1.67 | 1.68 |
| | #2 | 1,019 | 1.69 | |
| | #3 | 693 | 1.68 | |
| February 25 | #1 | 715 | 1.71 | 1.70 |
| | #2 | 758 | 1.68 | |
| | #3 | 1,053 | 1.72 | |
| March 4 | #1 | 968 | 1.67 | 1.76 |
| | #2 | 621 | 1.85 | |
| | #3 | 1,198 | 1.75 | |
| March 9 | #1 | 1,080 | 1.61 | 1.67 |
| | #2 | 942 | 1.81 | |
| | #3 | 820 | 1.60 | |

| | | |
|---|---|---|
| Average | 901 | 1.70 |

(2) Measurement of Lactobacillus Fermentation

Vegan cut kimchi was prepared according to Example and Cut Kimchi® by Shim Youngsoon was prepared, and an experiment for comparing the lactobacillus fermentation in the two kinds of kimchi was performed. Samples containing 200 g of each of the vegan cut kimchi and the Cut Kimchi by Shim Youngsoon were stored at 10° C. for 20 days, and ripened samples were used at intervals of 2 to 3 days. As the samples required for the experiment, 16 samples were prepared for a total of 8 times×2 kinds (Cut Kimchi/vegan cut kimchi) of products. A total of 8 times of experiment were performed at intervals of 3 days/2 days/2 days/3 days/4 days/3 days/3 days from the day of preparation.

Experimental items include fermentation of lactobacillus and general bacteria (the sample is diluted to 10¹ to 10⁹ using a Petri dish and cultured at 36° C. for hours and the number of colonies is counted), measurement of salinity and sugar content (the juice of sample is squeezed and the salinity and sugar content thereof are measured using a saccharometer and a salinity meter), and measurement of pH (the juice of sample is squeezed and diluted 10-fold with saline solution and the pH thereof is measured), and the measurement results are presented in the following Tables 3 and 4 and FIGS. 1 to 4.

TABLE 3

| | | Vegan cut kimchi | | | | | | |
|---|---|---|---|---|---|---|---|---|
| Sample | | Lactobacillus | | General bacteria | | | Salinity | Sugar content |
| Experimental items | | (CFU/ml) | | (CFU/ml) | | pH | (%) | (brix) |
| Storage period | Day 0 | 22084 | 2.3 × 10⁴ | 30920 | 3.1 × 10⁴ | 6.15 | 1.3 | 8.5 |
| (10° C.) | Day 3 | 49500 | 4.9 × 10⁴ | 220000 | 2.2 × 10⁵ | 6.18 | 1.8 | 11.7 |
| | Day 5 | 600000 | 6.0 × 10⁵ | 239000 | 2.4 × 10⁵ | 5.48 | 1.9 | 9.5 |
| | Day 7 | 19500000 | 2.0 × 10⁷ | 7115000 | 7.1 × 10⁶ | 4.20 | 1.9 | 10.3 |
| | Day 10 | 42666667 | 4.3 × 10⁷ | 5295000 | 5.3 × 10⁶ | 4.29 | 1.5 | 9.0 |
| | Day 14 | 13000000 | 1.3 × 10⁷ | 9595000 | 9.6 × 10⁶ | 4.26 | 2.0 | 8.8 |
| | Day 17 | 2535000 | 2.5 × 10⁶ | 3395000 | 3.4 × 10⁶ | 4.16 | 1.6 | 7.8 |
| | Day 20 | 3682000 | 3.7 × 10⁶ | 2012500 | 4.0 × 10⁶ | 4.15 | 1.7 | 8.5 |

TABLE 4

| | | Cut Kimchi | | | | | | |
|---|---|---|---|---|---|---|---|---|
| Sample | | Lactobacillus | | General bacteria | | | Salinity | Sugar content |
| Experimental items | | (CFU/ml) | | (CFU/ml) | | pH | (%) | (brix) |
| Storage period | Day 0 | 1640 | 1.6 × 10³ | 8550 | 8.6 × 10³ | 6.09 | 1.8 | 9.7 |
| (10° C.) | Day 3 | 82667 | 8.3 × 10⁴ | 18500 | 1.9 × 10⁴ | 6.25 | 1.9 | 9.6 |
| | Day 5 | 400000 | 4.0 × 10⁵ | 275000 | 2.8 × 10⁵ | 5.81 | 1.9 | 9.9 |
| | Day 7 | 47333333 | 4.7 × 10⁷ | 5565000 | 5.6 × 10⁶ | 4.54 | 2.1 | 10.6 |
| | Day 10 | 15000000 | 1.5 × 10⁷ | 6700000 | 6.7 × 10⁶ | 4.51 | 1.9 | 9.2 |
| | Day 14 | 16333333 | 1.6 × 10⁷ | 8812000 | 8.8 × 10⁶ | 4.34 | 2.0 | 8.9 |
| | Day 17 | 10604000 | 1.1 × 10⁷ | 10045000 | 1.0 × 10⁷ | 4.39 | 2.0 | 9.7 |
| | Day 20 | 9333333 | 9.3 × 10⁶ | 45400000 | 4.5 × 10⁷ | 4.37 | 2.0 | 9.2 |

As presented in Tables 3 and 4 and FIG. 1, it can be seen that lactobacillus fermentation in the vegan cut kimchi also proceeds in the same form as the graph for lactobacillus fermentation in the general cut kimchi. As time elapses, especially after Day 5, the number of lactobacillus increases rapidly, reaches a certain level and peaks, and then the lactobacillus becomes gradually extinct. The number of lactobacillus was highest on Day 7 in the general cut kimchi, and the number of lactobacillus was highest on Day 10 in the vegan cut kimchi. This indicates that general cut kimchi ripens more quickly than vegan cut kimchi even under the same conditions. Accordingly, the vegan cut kimchi has a slower growth rate of lactobacillus than general cut kimchi and is thus expected to be preserved longer.

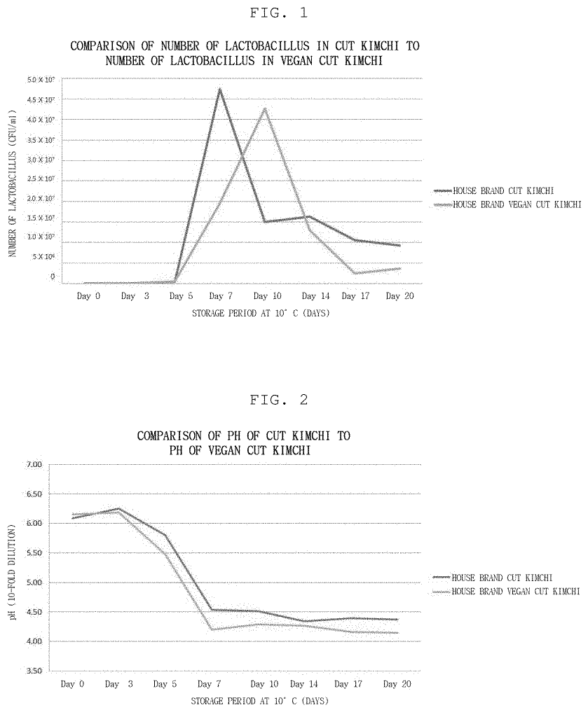

As presented in Tables 3, 4 and FIG. 2, from the graph for comparing the pH value of general cut kimchi to the pH value of vegan cut kimchi, it can be seen that the pH decreases to the lowest value from Day 7. During the fermentation process of kimchi, organic acids are produced by lactobacillus, which increases the acidity and decreases the pH, and this is the feature of kimchi fermentation. Both samples have a graph in which the pH decreases as lactobacillus begins to increase.

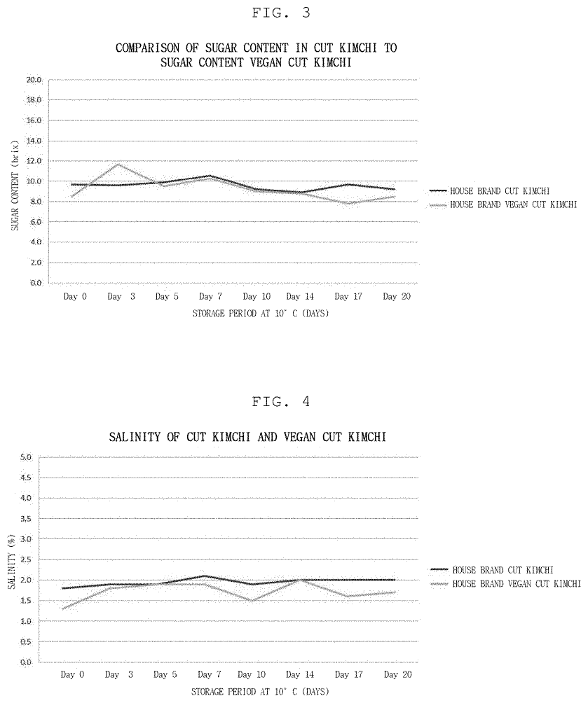

As presented in Tables 3 and 4 and FIGS. 3 and 4, significant changes in salinity and sugar content according to the fermentation of general cut kimchi and vegan cut kimchi are not acknowledged.

The vegan kimchi prepared according to the present invention retains the characteristics and taste of general kimchi, and provides crunchy physical characteristics since the vegan kimchi is salted two times using salty and sweet ingredients during the salting process.

The vegan kimchi according to the present invention has excellent preservability since the vegan kimchi has a slightly slower growth rate of lactobacillus than general kimchi containing animal ingredients, and thus has an effect of being easily commercialized and sold.

Features, structures, effects, and the like exemplified in each of the above-described embodiments may be combined or modified for other embodiments by those of skilled in the art to which the embodiments belong. Accordingly, the contents related to such combinations and modifications should be interpreted as being included in the scope of the present invention.

What is claimed is:

1. A method of preparing vegan kimchi, the method comprising:
a first salting step of salting napa cabbage for 16 to 20 hours using salting water containing refined salt and purified water at a concentration of 6% to 8% and draining the salted napa cabbage for 19 to 23 hours to obtain first salted napa cabbage;
a second salting step of adding a second salting mixture containing grated white radish at 45 to 50 wt %, grated onion at 45 to 50 wt %, roasted salt at 1 to 5 wt %, and sugar at 1 to 5 wt % to the first salted napa cabbage by 2.0 to 2.5 parts by weight based on 100 parts by weight of the first salted napa cabbage, salting the first salted napa cabbage for 50 to 70 minutes, and draining the salted napa cabbage for 20 to 40 minutes to obtain second salted napa cabbage; and
a condiment mixing step of adding vegan kimchi condiment containing Korean red chili flakes at 10 to 13 wt %, grated white radish at 5 to 7 wt %, grated onion at 22 to 25 wt %, grated apple at 0.1 to 0.8 wt %, vegetable broth at 15 to 22 wt %, glutinous rice paste at 5 to 7 wt %, grated garlic at 10 to 15 wt %, grated ginger at 1 to 4 wt %, soy sauce at 2 to 5 wt %, refined salt at 0.5 to 2.5 wt %, sugar at 4 to 8 wt %, and sliced green onion at 5 to 10 wt % to the second salted napa cabbage by 25 to 40 parts by weight based on 100 parts by weight of the first salted napa cabbage and mixing the second salted napa cabbage with the vegan kimchi condiment, wherein
the vegan kimchi condiment is prepared by soaking Korean red chili flakes in ingredients, which are not salty, including grated white radish, grated onion, grated apple, vegetable broth, and glutinous rice paste for 100 to 150 minutes and then mixing the soaked red chili flake mixture with salty ingredients including grated garlic, grated ginger, soy sauce, refined salt, sugar, and sliced green onion.

2. The method of preparing vegan kimchi according to claim 1, wherein the vegetable broth is obtained by adding at least three or more ingredients selected from the group consisting of cabbage, potato, white radish, onion, kelp, green onion, Cheongyang chili pepper, dried shiitake mushroom, and dried chili seed to purified water, boiling the mixture for 15 to 25 minutes, cooling the boiled mixture, and staining the boiled mixture through a strainer.
